(19) United States
(12) Patent Application Publication
(10) Pub. No.: US 2010/0164904 A1
(43) Pub. Date: Jul. 1, 2010

(54) CONTROL SIGNAL INPUT DEVICE AND METHOD USING DUAL TOUCH SENSOR

(76) Inventors: Su Myeon KIM, Suwon-si (KR); Won Keun Kong, Suwon-si (KR)

Correspondence Address: North Star Intellectual Property Law, PC, P.O. Box 34688, Washington, DC, 20043, US

(21) Appl. No.: 12/646,999

(22) Filed: Dec. 24, 2009

(30) Foreign Application Priority Data
Dec. 30, 2008 (KR) 10-2008-0136437

(51) Int. Cl. G06F 3/045

(52) U.S. Cl. 345/174

(57) ABSTRACT

A control signal input device and a control signal input method are provided. A control signal input device, includes a first touch sensor unit to output a first sensing signal in response to a first touch, a second touch sensor unit to output a second sensing signal in response to a second touch, and a control signal generation unit to generate an event control signal based on at least one of the first sensing signal and the second sensing signal.

### CROSS-REFERENCE TO RELATED APPLICATION(S)

This application claims the benefit under 35 U.S.C. §119(a) of a Korean Patent Application No. 10-2008-0136437, filed on Dec. 30, 2008, in the Korean Intellectual Property Office, the entire disclosure of which is incorporated herein by reference for all purposes.

### BACKGROUND

1. Field

The following description relates to a control signal input device and method using a dual touch sensor that may enable a user to control a handheld device using one hand.

2. Description of the Related Art

Due to the development and convergence of information technology, a variety of functions are available in portable devices. Different functions may require different types of inputs/outputs depending on characteristics of each function.

A device such as a display or a speaker may be used as an output device, and a button or touch pad may be used as an input device. A touch-based interface may be easily used by people of all ages, since it enables portable devices to be intuitively and interactively controlled simply by touching a button created on a display. For portable devices, a touch screen interface has come into the spotlight due to design superiority and convenience of use. Recent portable devices may be operated in various ways. For example, a portable device having a touch-based interface may generate an input signal by combining at least one touch, as opposed to previous touch-based portable devices that generate an input signal based on touching a single point. However, despite development in the touch interface, recent portable devices having a touch-based interface still generally require, for example, a user to use both hands for touch operations.

### SUMMARY

In one general aspect, a control signal input device includes a first touch sensor unit to output a first sensing signal in response to a first touch, a second touch sensor unit to output a second sensing signal in response to a second touch, and a control signal generation unit to generate an event control signal based on at least one of the first sensing signal and the second sensing signal.

The first touch sensor unit may include a display device, and the event control signal may render an event with respect to a content displayed on the display device.

The control signal input device may further include a memory unit to store an event pattern corresponding to a combination of the first sensing signal and the second sensing signal, wherein the control signal generation unit generates the event control signal based on the event pattern stored in the memory unit.

At least one motion of the first touch and the second touch corresponds to at least one of a single tap, a multi-tap, a drag, and a multiple drag, input using one or more fingers and/or a stylus pen.

The first touch may correspond to a drag in a first direction and the second touch may correspond to a drag in a second direction. In response to the first direction being opposite the second direction, the event control signal may correspond to an event to zoom in with respect to the content. In response to the first direction and the second direction being towards each other, the event control signal may correspond to an event to zoom out with respect to the content.

In response to the first touch and the second touch corresponding to two single taps both made within a predetermined time interval, the event control signal may correspond to an event to enable the two single taps to be recognized as a double tap in a location where the first touch occurs or in a location where the second touch occurs.

In response to the second touch corresponding to a multiple tap and the content being a web page, the event control signal may correspond to an event to display a main page of the web page.

The control signal generation unit may calculate a first sensing signal corresponding to the second sensing signal, and generate the event control signal corresponding to a predetermined event based on the calculated first sensing signal.

The second sensing signal may be output in response to a drag in the second touch sensor unit in a first direction, and the event control signal may correspond to an event to enable the content displayed on the display device of the first touch sensor unit to move to the first direction.

In another general aspect, a control signal input method of a control signal input device having a first touch sensor unit and a second touch sensor unit, includes receiving a first sensing signal in response to a first touch with respect to the first touch sensor unit, receiving a second sensing signal in response to a second touch with respect to the second touch sensor unit, and generating an event control signal based on at least one of the first sensing signal and the second sensing signal.

The first touch sensor unit may include a display device, and the event control signal may render an event with respect to a content displayed on the display device.

The generating of the event control signal may include confirming a first direction of the first touch and a second direction of the second touch in response to the first touch and the second touch corresponding to a drag, and generating the event control signal corresponding to an event to zoom in with respect to the content, in response to the first direction being opposite the second direction. The generating of the event control signal may further include generating the event control signal corresponding to an event to zoom out with respect to the content, in response to the first direction and the second direction being towards each other.

The generating of the event control signal may include determining whether the first touch and the second touch are two single taps both made within a predetermined time interval, and generating the event control signal corresponding to an event to enable the two single taps to be recognized as a double tap in a location where the first touch occurs or in a location where the second touch occurs, in response to the first touch and the second touch being the two single taps made within the predetermined time interval.

The generating of the event control signal may include calculating a first sensing signal corresponding to the second sensing signal, and generating the event control signal corresponding to a predetermined event based on the calculated first sensing signal. The second sensing signal may be output in response to a drag in the second touch sensor unit in a first direction, and the event control signal may correspond to an event to enable the content displayed on the display device of the first touch sensor unit to move to the first direction.

Other features and aspects will be apparent from the following detailed description, the drawings, and the claims.

### BRIEF DESCRIPTION OF THE DRAWINGS

FIG. 1 is a block diagram illustrating an exemplary control signal input device.

FIG. 2 is a diagram illustrating an exemplary handheld device where the control signal input device of FIG. 1 is applied.

FIGS. 3 through 7 are diagrams illustrating examples of inputting a control signal in exemplary handheld devices.

FIG. 8 is a flowchart illustrating an exemplary control signal input method.

Throughout the drawings and the detailed description, unless otherwise described, the same drawing reference numerals will be understood to refer to the same elements and structures. The relative size and depiction of these elements may be exaggerated for clarity, illustration, and convenience.

### DETAILED DESCRIPTION

The following detailed description is provided to assist the reader in gaining a comprehensive understanding of the media, apparatuses, methods and/or systems described herein. Accordingly, various changes, modifications, and equivalents of the systems, methods, apparatuses and/or media described herein will be suggested to those of ordinary skill in the art. Also, descriptions of well-known functions and constructions may be omitted for increased clarity and conciseness.

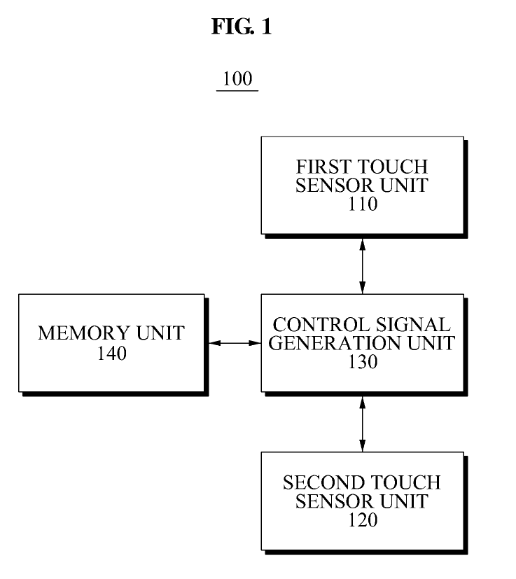

FIG. 1 illustrates an exemplary control signal input device 100. The control signal input device 100 includes a first touch sensor unit 110, a second touch sensor unit 120, and a control signal generation unit 130.

The first touch sensor unit 110 may output a first sensing signal in response to a first touch. The second touch sensor unit 120 may output a second sensing signal in response to a second touch.

Each of the first touch sensor unit 110 and the second touch sensor unit 120 may be located on different sides of a handheld device.

As an illustration and without limiting thereto, a handheld device described herein may refer to devices such as a mobile communication terminal, a portable phone, a portable laptop, a personal digital assistant (PDA), a portable multimedia player (PMP), a moving picture experts group (MPEG) audio-layer 3 (MP3) player, a mobile Internet device (MID), and the like. The handheld device in some exemplary implementations may have a touch panel on at least two sides, and other exemplary implementations may include two touch panels on different sides in response to, for example, sliding, flipping, rotating and/or configuring the handheld device to reveal at least one of the two touch panels. This is only exemplary and it is understood that other configurations are possible in other implementations consistent with the instant disclosure.

Hereinafter, the control signal input device 100 as applied to an exemplary handheld device having the first touch sensor unit 110 located on a first side, for example, a front side, and the second touch sensor unit 120 located on a second side, for example, a back side, of the handheld device is described for illustration.

The first touch and the second touch may correspond to at least one of a single tap, a multi-tap, a single drag, a multiple drag, and the like. Also, the first touch and the second touch may be inputted using fingers, a stylus pen, and the like.

The control signal generation unit 130 may generate an event control signal based on at least one of the outputted first sensing signal and the outputted second sensing signal. Also, the control signal generation unit 130 may generate an event control signal based on a combination of the outputted first sensing signal and the outputted second sensing signal.

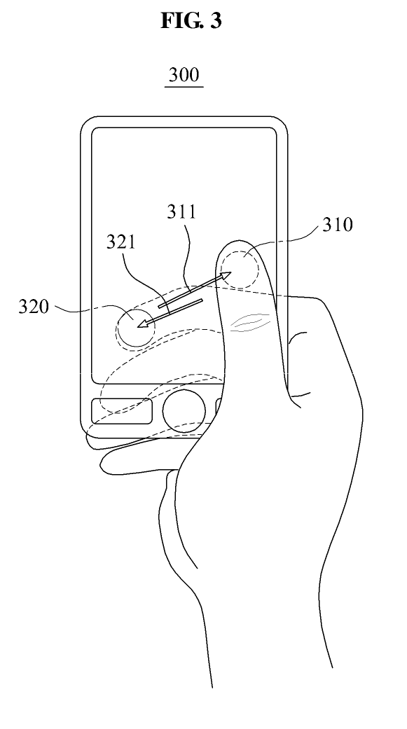

The event control signal generated based on various combinations and an event, generated based on the event control signal, are further described below with reference to FIGS. 3 through 7.

The first touch sensor unit 110 may include a display device. Also, the first touch sensor unit 110 may function as a module to sense a touch on a touch screen. When the display device is included in the first touch sensor unit 110, the first touch sensor unit 110 may function as the touch screen itself. In this case, a predetermined event may be generated as contents, displayed on the display device, through the first touch sensor unit 110 based on the event control signal generated by the control signal generation unit 130. For example, contents displayed on the display device may be controlled by a combination of a touch on the first touch sensor unit 110 and a touch on the second touch sensor unit 120. The first touch sensor unit 110 may be located on the front side of the handheld device.

The predetermined event generated by the event control signal is further described below with reference to FIGS. 3 through 7.

The control signal input device 100 may further include a memory unit 140. The memory unit 140 may store an event pattern corresponding to, for example, the combination of the first sensing signal and the second sensing signal. In this case, the control signal generation unit 130 may generate the event control signal based on the event pattern stored in the memory unit 140.

The memory unit 140 may be updated by a manufacturer of the control signal input device 100 or a contents provider. Accordingly, the handheld device to which the control signal input device 100 is applied may update a variety of control events without additional hardware.

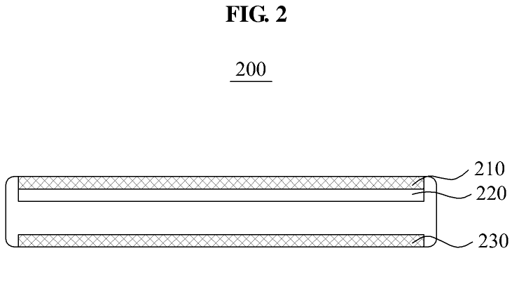

FIG. 2 illustrates an exemplary handheld device 200 to which a control signal input device 100 of FIG. 1 is applied. The handheld device 200 includes a first touch sensor unit 210 and a display device 220 on a first side, for example, a front side, of the handheld device 200, and a second touch sensor unit 230, which is independent from the first touch sensor unit 210, on a second side, for example, a back side, of the handheld device 200.

Although it is illustrated that the display device 220 is located on only the front side of the handheld device 200 in FIG. 2, the handheld device 200 may be provided so that the display device 220 is located on both the front side and the back side of the handheld device 200.

In the handheld device 200, a variety of operations are available based on various combinations made by touching two sides, that is, two touch sensor units, in comparison to touching only one side, that is, one touch sensor unit. Moreover, a user may more easily control the handheld device 200 using one hand.

FIGS. 3 through 7 illustrate examples of inputting a control signal in a handheld device consistent with the instant disclosure.

As an illustration, a first touch sensor unit and a display device located on a first side, for example, a front side, of the handheld device may be independent from each other. The first touch sensor unit and the display device may function as a touch screen that may simultaneously perform displaying and inputting. Also, the handheld device described below may be a handheld device to which the control signal input device 100 of FIG. 1 is applied. Moreover, a first touch sensor unit may refer to that of FIG. 1 or FIG. 2, a second touch sensor unit may refer to that of FIG. 1 or FIG. 2, a display device may refer to that of FIG. 2, a memory unit may refer to that of FIG. 1, and a control signal generation unit may refer to that of FIG. 1.

In FIG. 3, a first touch may correspond to a drag in a first direction 311 and a second touch may correspond to a drag in a second direction 321. For example, the first touch may correspond to dragging of a thumb 310 of a user in the first direction 311 on a first touch sensor unit. The first touch sensor unit may be located on a front side of a handheld device 300. Also, the second touch may correspond to dragging of an index finger 320 of the user in the second direction 321 on a second touch sensor unit. The second touch sensor unit may be located on a back side of the handheld device 300.

In this example, when the first direction 311 is opposite to the second direction 321, the control signal input device 100 may process contents displayed on the display device to be zoomed in. The display device may be located on the front side of the handheld device 300.

That is, referring to FIG. 1, the first touch sensor unit 110 of the control signal input device 100 may generate a first sensing signal based on the first touch, that is, the drag in the first direction 311, and the second touch sensor unit 120 of the control signal input device 100 may generate a second sensing signal based on the second touch, that is, the drag in the second direction 321. Accordingly, the control signal generation unit 130 may generate an event control signal to zoom in on the contents in response to the generated first sensing signal and the generated second sensing signal.

The display device of the handheld device 300 may enlarge and display the contents based on the generated event control signal.

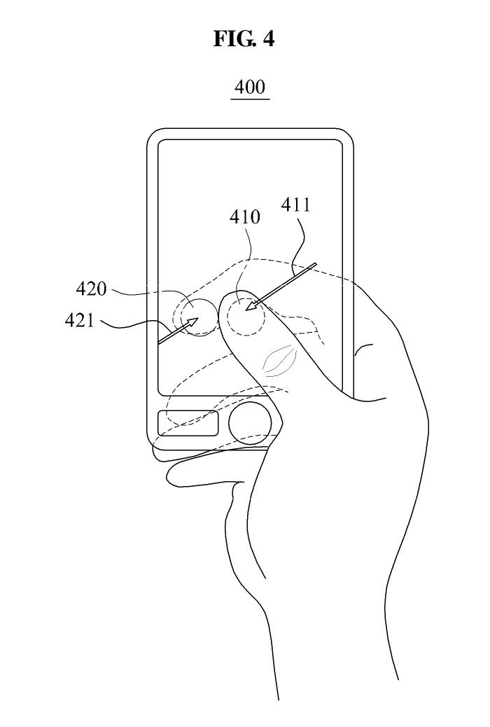

In FIG. 4, a first touch may correspond to a drag in a first direction 411 and a second touch may correspond to a drag in a second direction 421.

For example, the first touch may correspond to dragging of a thumb 410 of a user in the first direction 411 on a first touch sensor unit. The first touch sensor unit may be located on a front side of a handheld device 400. Also, the second touch may correspond to dragging of an index finger 420 of the user in the second direction 421 on a second touch sensor unit. The second touch sensor unit may be located on a back side of the handheld device 400.

In this example, when the first direction 411 and the second direction 421 are towards each other, the control signal input device 100 may process contents displayed on a display device to be zoomed out. The display device may be located on the front side of the handheld device 400.

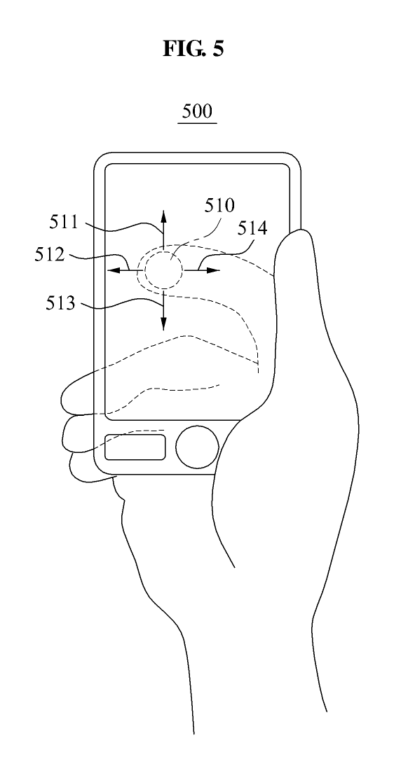

In FIG. 5, a user may control a display device, which is located on a side opposite to a second touch sensor unit, by touching the second touch sensor unit.

The control signal input device 100 may recognize a sensing signal from the second touch sensor unit (“second sensing signal”) as a first sensing signal, and generate an event control signal. That is, a control signal generation unit of the control signal input device 100 may calculate the first sensing signal corresponding to the second sensing signal, and generate the event control signal to generate the predetermined event based on the calculated first sensing signal.

When the second sensing signal is outputted in response to a drag in a first direction, the event control signal may be generated corresponding to an event to enable contents displayed on the display device to move to the first direction and to be displayed. The display device may be located on a front side of a handheld device 500.

The handheld device 500 to which the control signal input device 100 is applied may control the display device using the second sensing signal outputted by the second sensor unit located on a back side of the handheld device 500.

In an existing operation of a touch screen, the content moving operation described above with reference to FIG. 5 may be performed by controlling a display based on a touch on a touch panel, in which the display and the touch panel are located on the same side, for example, a front side, of a handheld device where the touch screen is provided. In this case, a blind spot may be generated, for example, a user's touch covering part of the display.

In FIG. 5, the control signal input device 100 may control the display device, located on the front side of the handheld device 500, based on a touch occurring on a touch panel located on the back side of the handheld device 500. Accordingly, a blind spot may not be generated or reduced. That is, finger(s) used for touching may be prevented from hiding the display.

Referring back to FIG. 5, a touch illustrated in FIG. 5 may correspond to a drag in one of the predetermined directions 511, 512, 513, and 514. That is, the touch may correspond to dragging of an index finger 510 of a user in one of the predetermined directions 511, 512, 513, and 514 on the second touch sensor unit located on the back side of the handheld device 500.

Here, when the touch corresponds to dragging of the index finger 510 in the first direction 511, an event to enable contents displayed on the front side of the handheld device 500 to move upward may be generated. This type of event may be used for, for example, scrolling of a web page, changing a center of map data, and the like. Accordingly, a blind spot in the display device may be reduced or avoided.

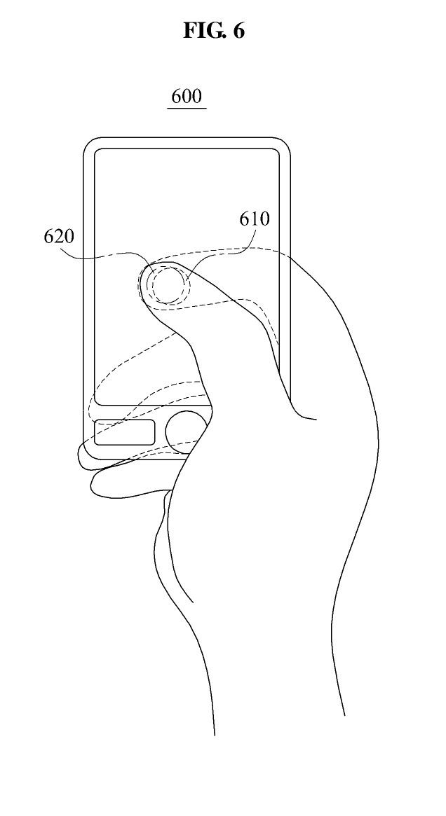

In FIG. 6, when a first touch and a second touch correspond to two single taps both made within a predetermined time interval, an event control signal may be generated corresponding to an event to enable the two single taps to be recognized as a double tap in a location where the first touch occurs.

For example, a first touch sensor unit may output a first sensing signal based on a single tap of a thumb 610. The first touch sensor unit may be located on a front side of a handheld device 600. A second touch sensor unit may output a second sensing signal based on a single tap of an index finger 620. The second touch sensor unit may be located on a back side of the handheld device 600.

When the first sensing signal and the second sensing signal are generated within a predetermined time interval, for example, both are generated almost simultaneously, the handheld device 600 may recognize the two single taps as the double tap occurring on the first touch sensor unit.

The two single taps may generate an event different from an event generated when a touch occurs on any one of the front side and the back side. As an illustration, the combined touch illustrated in FIG. 6 may be recognized as a double-clicking in a mouse connected to a personal computer.

Accordingly, the double tap on a single touch sensor unit may be replaced with the combined single tap. Thus, time spent to control the handheld device 600 may be reduced.

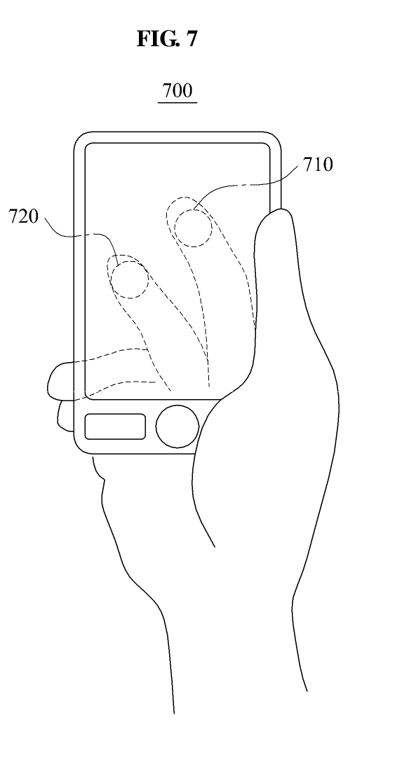

In FIG. 7, a predetermined event may be generated for displayed contents based on two single taps of an index finger 710 and a middle finger 720 through a handheld device 700.

That is, a second touch sensor unit located on a back side of the handheld device 700 may receive a multi-tap of the index finger 710 and the middle finger 720 and generate a sensing signal. In response, a control signal generation unit of the control signal input device 100 may generate an event control signal corresponding to the predetermined event for the contents displayed on a display device, based on the sensing signal.

For example, the contents may be a web page, and the event control signal may correspond to an event to enable a main page of the web page to be displayed.

As another example, the event control signal may control the web page to be connected to a home Uniform Resource Locator (URL) which is loaded when operating a browser.

Various event patterns described above with reference to FIGS. 3 through 7 may be executed by the event control signal generated by the control signal generation unit. Also, the event control signal may be generated based on a combination of sensing signals outputted from touch panels located on different sides.

The control signal input device 100 may store the event patterns in association with each of the combination of the sensing signals in a memory unit.

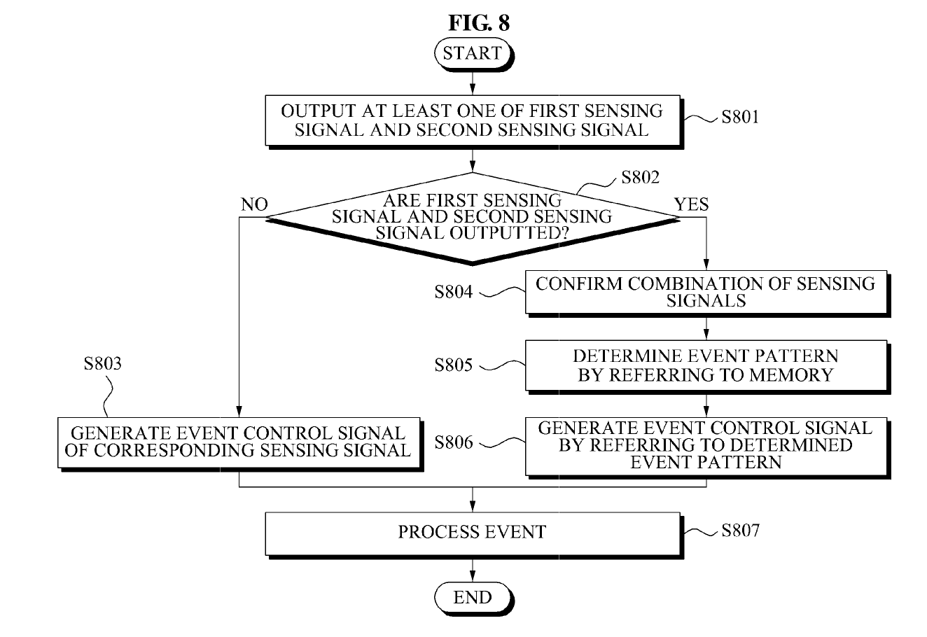

FIG. 8 illustrates an exemplary control signal input method. The method may be carried out by a control signal input device and/or a handheld device described above.

In operation S801, at least one of a first sensing signal and a second sensing signal is output.

The first sensing signal may be outputted from a first touch sensor unit in response to a first touch. The second sensing signal may be outputted from a second touch sensor unit in response to a second touch.

In operation S802, whether both the first sensing signal and the second sensing signal are outputted is determined.

In operation S803, when only one of the first sensing signal and the second sensing signal is outputted, an event control signal corresponding to the outputted sensing signal is generated.

In operation S807, a corresponding event based on the generated event control signal is processed.

For example, when only the first sensing signal is outputted, a predetermined event may be generated on a touch screen in a front side of a handheld device.

When only the second sensing signal is outputted, a first sensing signal corresponding to the second sensing signal may be calculated, and the event control signal corresponding to a predetermined event on the touch screen may be generated based on the calculated first sensing signal.

When it is determined that both the first sensing signal and the second sensing signal are outputted in operation S802, a combination of the first sensing signal and the second sensing signal is confirmed in operation S804.

In operation S805, an event pattern corresponding to the confirmed combination is determined by referring to a memory.

In operation S806, an event control signal is generated based on the determined event pattern.

The generated event control signal may be a signal for generating a predetermined event with respect to contents displayed on the touch screen. For example, when the first touch and the second touch correspond to a drag, a first direction of the first touch and a second direction of the second touch may be confirmed, and a corresponding event pattern may be determined. When the first direction is opposite to the second direction, an event pattern corresponding to zooming in with respect to the contents may be determined, and an event control signal may be generated based on the determined event pattern. When the first direction and the second direction are towards each other, an event pattern corresponding to zooming out with respect to the contents may be determined, and an event control signal may be generated based on the determined event pattern.

As another example, when the first touch and the second touch correspond to two single taps both made within a predetermined time interval, an event pattern may be determined as corresponding to a double tap in a location where the first touch occurs.

Accordingly, the corresponding event control signal may be generated based on the determined event pattern in operation S806.

In operation S807, again, a corresponding event based on the generated event control signal is processed.

The methods described above including a control signal input method may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

The flash memory devices may be non-volatile memory devices that can maintain stored data even when power is cut off. According to an increase in the use of mobile devices such as a cellular phone, a personal digital assistant (PDA), a digital camera, a portable game console, and an MP3 player, the flash memory devices may be more widely used as data storage and code storage. The flash memory devices may be used in home applications such as a high definition television (HDTV), a DVD, a router, and a Global Positioning System (GPS).

According to certain example(s) described above, a user may control a handheld device using only one hand holding the handheld device.

According to certain example(s) described above, a blind spot occurring on a display device may be reduced or avoided. Also, a double tap input may be replaced with a combined single tap to reduce time spent controlling a handheld device.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A control signal input device, comprising:
a first touch sensor unit to output a first sensing signal in response to a first touch;
a second touch sensor unit to output a second sensing signal in response to a second touch; and
a control signal generation unit to generate an event control signal based on at least one of the first sensing signal and the second sensing signal.

2. The control signal input device of claim 1, wherein:
the first touch sensor unit comprises a display device, and
the event control signal renders an event with respect to a content displayed on the display device.

3. The control signal input device of claim 1, further comprising:
a memory unit to store an event pattern corresponding to a combination of the first sensing signal and the second sensing signal,
wherein the control signal generation unit generates the event control signal based on the event pattern stored in the memory unit.

4. The control signal input device of claim 1, wherein at least one motion of the first touch and the second touch corresponds to at least one of a single tap, a multi-tap, a drag, and a multiple drag, input using one or more fingers and/or a stylus pen.

5. The control signal input device of claim 2, wherein the first touch corresponds to a drag in a first direction and the second touch corresponds to a drag in a second direction.

6. The control signal input device of claim 5, wherein, in response to the first direction being opposite the second direction, the event control signal corresponds to an event to zoom in with respect to the content.

7. The control signal input device of claim 5, wherein, in response to the first direction and the second direction being towards each other, the event control signal corresponds to an event to zoom out with respect to the content.

8. The control signal input device of claim 2, wherein, in response to the first touch and the second touch corresponding to two single taps both made within a predetermined time interval, the event control signal corresponds to an event to enable the two single taps to be recognized as a double tap in a location where the first touch occurs or in a location where the second touch occurs.

9. The control signal input device of claim 2, wherein in response to the second touch corresponding to a multiple tap and the content being a web page, the event control signal corresponds to an event to display a main page of the web page.

10. The control signal input device of claim 2, wherein the control signal generation unit calculates a first sensing signal corresponding to the second sensing signal, and generates the event control signal corresponding to a predetermined event based on the calculated first sensing signal.

11. The control signal input device of claim 10, wherein the second sensing signal is output in response to a drag in the second touch sensor unit in a first direction, and the event control signal corresponds to an event to enable the content displayed on the display device of the first touch sensor unit to move to the first direction.

12. A control signal input method of a control signal input device having a first touch sensor unit and a second touch sensor unit, the method comprising:
receiving a first sensing signal in response to a first touch with respect to the first touch sensor unit;
receiving a second sensing signal in response to a second touch with respect to the second touch sensor unit; and
generating an event control signal based on at least one of the first sensing signal and the second sensing signal.

13. The control signal input method of claim 12, wherein:
the first touch sensor unit comprises a display device, and
the event control signal renders an event with respect to a content displayed on the display device.

14. The control signal input method of claim 13, wherein the generating of the event control signal comprises:
confirming a first direction of the first touch and a second direction of the second touch in response to the first touch and the second touch corresponding to a drag; and
generating the event control signal corresponding to an event to zoom in with respect to the content, in response to the first direction being opposite the second direction.

15. The control signal input method of claim 14, the generating of the event control signal further comprises generating the event control signal corresponding to an event to zoom out with respect to the content, in response to the first direction and the second direction being towards each other.

16. The control signal input method of claim 13, wherein the generating of the event control signal comprises:
determining whether the first touch and the second touch are two single taps both made within a predetermined time interval; and
generating the event control signal corresponding to an event to enable the two single taps to be recognized as a double tap in a location where the first touch occurs or in a location where the second touch occurs, in response to the first touch and the second touch being the two single taps made within the predetermined time interval.

17. The control signal input method of claim 13, wherein the generating of the event control signal comprises:
calculating a first sensing signal corresponding to the second sensing signal; and
generating the event control signal corresponding to a predetermined event based on the calculated first sensing signal.

18. The control signal input method of claim 17, wherein the second sensing signal is output in response to a drag in the second touch sensor unit in a first direction, and the event control signal corresponds to an event to enable the content displayed on the display device of the first touch sensor unit to move to the first direction.

19. A computer-readable storage medium storing a program to implement a control signal input method of a control signal input device having a first touch sensor unit and a second touch sensor unit, comprising:
receiving a first sensing signal in response to a first touch with respect to the first touch sensor unit;
receiving a second sensing signal in response to a second touch with respect to the second touch sensor unit; and
generating an event control signal based on at least one of the first sensing signal and the second sensing signal.
